(19) United States
(12) Patent Application Publication
(10) Pub. No.: US 2004/0141444 A1
(43) Pub. Date: Jul. 22, 2004

(54) Pickup inspecting apparatus

(75) Inventors: Chul-Soo Park, Seoul City (KR); Jae-Hyun Jung, Anyang City (KR); Byeong-Hwan Jeon, Yongin City (KR); Jong-Il Kee, Suwon City (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/616,035

(22) Filed: Jul. 10, 2003

(30) Foreign Application Priority Data
Dec. 16, 2002 (KR) 2002-80342

(51) Int. Cl. G11B 7/00

(52) U.S. Cl. 369/53.28

(57) ABSTRACT

A pickup inspecting apparatus inspecting performance of a pickup to be mounted on a disk drive and reading data from a disk includes a disk driving unit rotatably supporting a disk, and a plurality of pickup transferring units disposed around the disk driving unit and each holding the pickup and transferring the pickup to the disk driving unit so as to read data recorded on the disk, so that a plurality of pickups are inspected at once. An inspection efficiency of the pickup inspecting unit is improved.

### CROSS-REFERENCE TO RELATED APPLICATIONS

This application claims the benefit of Korean Patent Application No. 2002-80342, filed Dec. 16, 2002, in the Korean Intellectual Property Office, the disclosure of which is incorporated herein by reference.

### BACKGROUND OF THE INVENTION

1. Field of the Invention

The present invention relates to a pickup inspecting apparatus, and more particularly, to a pickup inspecting apparatus inspecting performance of a pickup mounted in a disk drive and reading data from a disk.

2. Description of the Related Art

Generally, a disk drive, such as a CD-ROM (compact disk read only memory) drive, a CD-RW (compact disk rewritable) drive, a DVD (digital versatile disk) drive, etc., is mounted with a pickup to read/write data from/on a disk.

The pickup includes a photo diode emitting a laser beam, an actuator mounted with an objective lens focusing the laser beam emitted from the photo diode onto the disk, etc.

In a process of manufacturing the pickup, performance of the pickup is inspected by a pickup inspecting apparatus after the pickup has been assembled.

FIGS. 1 through 3 illustrate a conventional pickup inspecting apparatus 101. As shown in FIGS. 1 through 3, the pickup inspecting apparatus 101 includes a pickup holder 121 holding a pickup 110, an angle adjusting part 125 provided under the pickup holder 121 to adjust an angle of the pickup 110 held by the pickup holder 121 with respect to the pickup inspecting apparatus 101, a disk driving unit 130 supporting and rotating a disk 103 having predetermined data to inspect the performance of the pickup 110, a feed motor 127 transferring the disk driving unit 130 to the pickup holder 121 holding the pickup 110, a determiner (not shown) determining whether the pickup 110 passes predetermined inspections based on a first signal received from the pickup 110, a controller initializing the pickup 110 and the disk 103 and controlling the pickup 110 and the disk 103, respectively, by a second signal received from the determiner, and a computer system (not shown) displaying a determination of whether the pickup 110 passes the predetermined inspections based on the second signal transmitted from the determiner.

The pickup 110 includes a photo diode (not shown) emitting a laser beam, an actuator (not shown) mounted with an objective lens focusing the laser beam emitted from the photo diode onto the disk 103, etc., and is employed for reading/writing the data from/on the disk 103 mounted in the disk drive. Hereinafter, the pickup 110 will be described based on an assumption that the pickup 110 is put on the pickup inspecting apparatus 101 inspecting the performance of the pickup 110 before the pickup 110 is mounted in the disk drive.

The pickup holder 121 detachably holds and supports the pickup 110. The angle adjusting part 125 is provided under the pickup holder 121 and includes a first skew motor 125a and a second skew motor 125b which are controlled by the controller to adjust the angle of the pickup 110 held by the pickup holder 121 with respect to the pickup inspecting apparatus 101.

The disk driving unit 130 includes a shaft 131 which the disk 103 is coupled to and supported on, a supporting plate 132 rotatably supporting the shaft 131, and a spindle motor 135 provided above the supporting plate 132 and connected to the shaft 131 to rotate the disk 103. Here, the controller controls the spindle motor 135 to rotate the shaft 131, so that the disk 103 coupled to the shaft 131 is rotated.

The feed motor 127 is seated behind the disk driving unit 130 and connected to the supporting plate 132 by a spindle 128. The spindle 128 has first external threads, and a rear portion of the supporting plate 131 has second internal threads to be engaged with the first external threads of the spindle 128. Hence, when the feed motor 127 rotates the spindle 128, the supporting plate 132 coupled to the spindle 128 by a screw-nut combination moves forward and backward, and a moving direction of the supporting plate 132 varies according to a rotating direction of the feed motor 127 controlled by the controller.

The determiner determines whether the pickup 110 passes the predetermined inspections based on the first signal received from the pickup 110 reading the data recorded on the disk 103, and transmits a part of the first signal received from the pickup 110 to the controller and a determination signal, e.g., the second signal, to the computer system to display the determination.

The controller controls the angle adjusting part 125 and the feed motor 127 to initialize the pickup 110 and the disk 103, respectively, when the pickup 110 is put on the pickup holder 121 and controls the laser beam emitted from the photo diode of the pickup 110. Further, the controller receives the first signal of the pickup 110 from the determiner and then controls the angle adjusting part 125, the feed motor 127 and the spindle motor 135 to change a relative position of the pickup 110 and the disk 103.

The computer system initially transmits a third signal to the controller and the determiner so as to control and determine initial positions of the pickup 110 and the disk 103, and displays the determination of whether the pickup 110 passes the predetermined inspections based on the determination signal received from the determiner.

With this configuration, the conventional pickup inspecting apparatus 101 operates as follows. First, the pickup 110 is put on the pickup holder 121, and the disk 103 is coupled to the shaft 131. Then, the computer system transmits the third signal to the controller, so that the controller controls the angle adjusting part 125, the feed motor 127 and the spindle motor 135 to initialize the pickup 110 and the disk 103. Further, the computer system transmits the third signal to the determiner, so that the determiner determines whether the pickup 110 passes one of the predetermined inspections based on the first signal received from the pickup 110 reading the data of the disk 103. Then, the determiner transmits the part of the first signal received from the pickup 110 to the controller and the determination signal to the computer system to display the determination. Then, the controller controls the relative position between the pickup 110 and the disk 103 to be changed for a next inspection, e.g., another one of the predetermined inspections, after receiving the determination signal from the determiner. Here, the determiner receives again the first signal from the pickup 110 and determines whether the pickup 110 passes the next inspection, and thus the above-described operations are repeated until a programmed inspection is finished, thereby determining whether the performance of the pickup 110 is inferior, and displaying the determination on the computer system.

However, the conventional pickup inspecting apparatus 101 inspects only one pickup 110 in each inspecting process, so that it consumes relatively much time and labor in order to inspect a lot of pickups 110, thereby lowering an inspection efficiency and increasing a production cost because of a low efficiency.

### SUMMARY OF THE INVENTION

Accordingly, it is an aspect of the present invention to provide a pickup inspecting apparatus improving inspection efficiency of inspecting a plurality of pickups.

Additional aspects and advantages of the invention will be set forth in part in the description which follows and, in part, will be obvious form the description, or may be learned by practice of the invention.

The foregoing and/or other aspects of the present invention are achieved by providing a pickup inspecting apparatus inspecting a performance of a plurality of pickups to be mounted in a disk drive and reading data from a disk. The pickup inspecting apparatus includes a disk driving unit rotatably supporting a disk, and a plurality of pickup transferring units disposed around the disk driving unit and each holding a corresponding ones of the pickups and transferring the pickups to the disk driving unit so as to read data recorded on the disk, so that the pickups are inspected at once.

According to another aspect of the invention, the disk driving unit includes a shaft on which the disk is supported, and a spindle motor connected to the shaft to rotate the disk.

According to another aspect of the invention, each pickup transferring unit includes a pickup holder holding the pickup, an angle adjusting part connected to the pickup holder to adjust an angle of the pickup holder with respect to the pickup inspecting apparatus, and a feed motor connected to the angle adjusting part to transfer the pickup held by the pickup holder to the disk driving unit.

According to another aspect of the invention, the pickup inspecting apparatus further includes a base member on which the disk driving unit and the pickup transferring unit are seated, wherein the spindle motor is seated on the base member, the shaft is connected to the spindle motor, and the disk is coupled to the shaft so as to rotate together with the shaft.

According to another aspect of the invention, the pickup inspecting apparatus further includes a guide block combined with the angle adjusting part under the angle adjusting part, and a guide rail provided on the base member to guide the guide block wherein the feed motor is connected to the guide block and moves the guide block along the guide rail.

According to another aspect of the invention, four pickup transferring units are arranged around one disk driving unit and disposed in different radial directions of the shaft of the disk driving unit to transfer the corresponding pickups to the disk driving unit in corresponding ones of the radial directions of the shaft of the disk driving unit.

According to another aspect of the invention, the pickup inspecting apparatus further includes a determiner transmitting a signal received from each pickup by a time division method, and a controller controlling each pickup by receiving the signal of the corresponding pickup through the determiner according to the time division method.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a perspective view of a conventional pickup inspecting apparatus;

FIG. 2 is a plan view of the pickup inspecting apparatus of FIG. 1;

FIG. 3 is a front view of the pickup inspecting apparatus of FIG. 1;

FIG. 4 is a plan view of a pickup inspecting apparatus according to an embodiment of the present invention;

FIGS. 5A and 5B are sectional views of the pickup inspecting apparatus of FIG. 4; and

FIG. 6 is a block diagram of the pickup inspecting apparatus of FIG. 4.

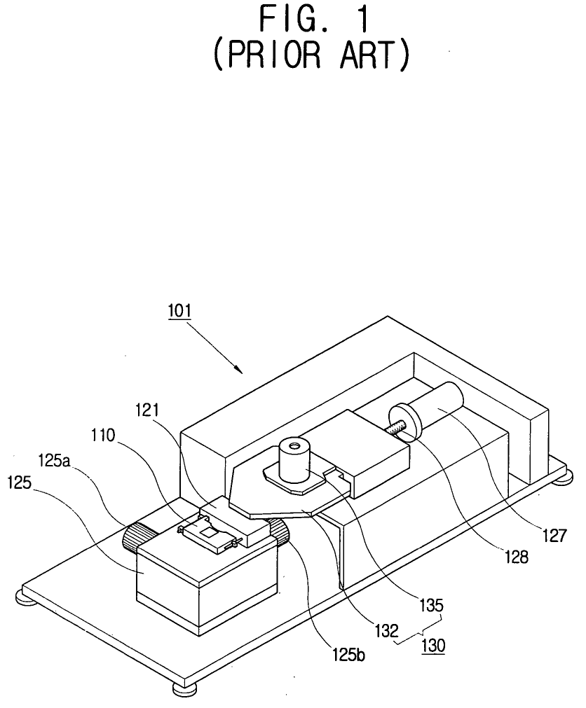

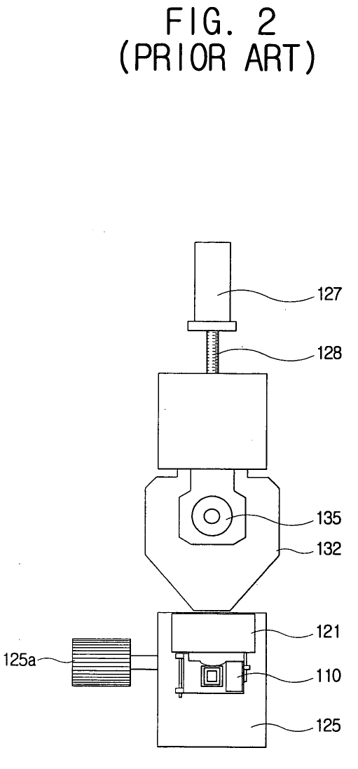

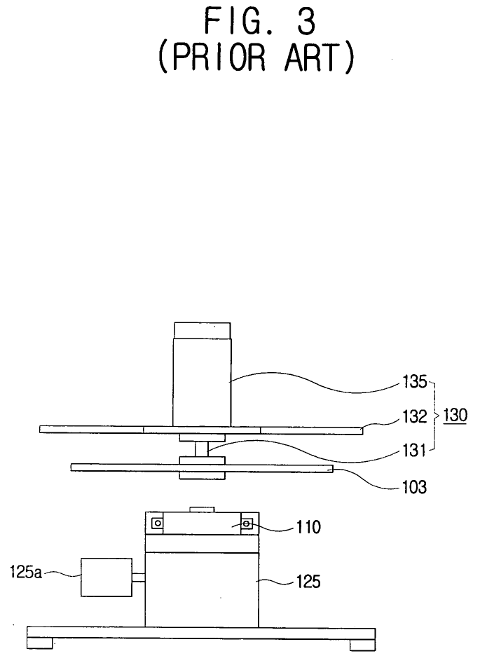

### DETAILED DESCRIPTION OF THE PREFERRED EMBODIMENTS

Reference will now be made in detail to the embodiment of the present invention, examples of which are illustrated in the accompanying drawings, wherein like reference numerals refer to like elements throughout. The embodiment is described below in order to explain the present invention by referring to the figures.

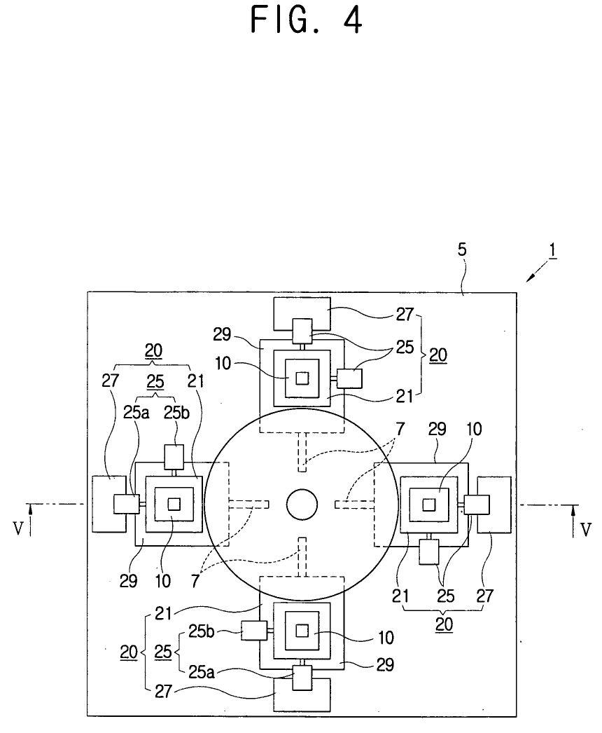

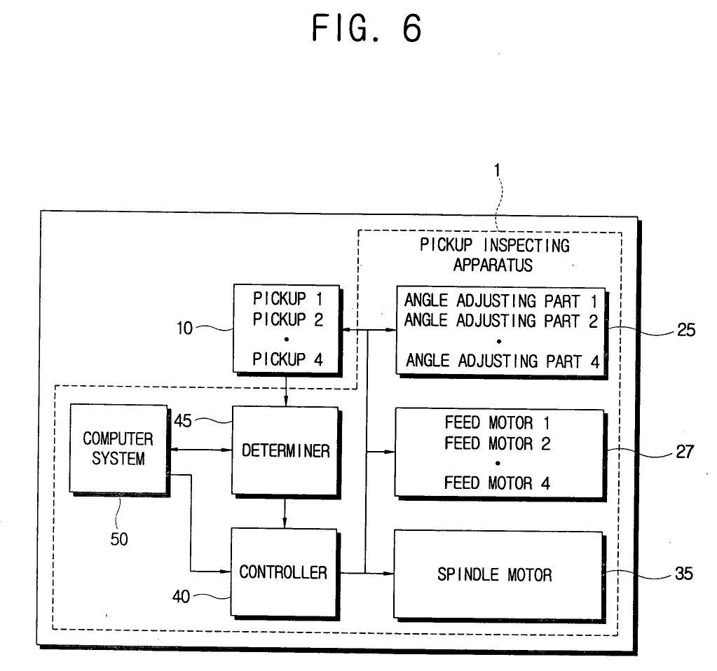

As shown in FIGS. 4 through 6, a pickup inspecting apparatus 1 according to an embodiment of the present invention includes a disk driving unit 30 supporting and rotating a disk 3 having predetermined data to inspect performance of a pickup 10, and a pickup transferring unit 20 holding the pickup 10 and transferring the pickup 10 to the disk driving unit 30 so as to read the data recorded on the disk 3. The pickup inspecting apparatus 1 includes four pickup transferring units 20 with respect to one disk driving unit 30, so that four pickups 10 are inspected at once.

The pickup 10 includes a photo diode (not shown) emitting a laser beam, an actuator (not shown) mounted with an objective lens focusing the laser beam emitted from the photo diode onto the disk 3, etc., and is employed in a disk drive reading/writing data from/on the disk 3 disposed on the disk drive. Hereinafter, the pickup 10 will be described based on an assumption that the pickup 10 is put on the pickup inspecting apparatus 1 inspecting the performance of the pickup 10 before the pickup 10 is mounted in the disk drive.

The disk driving unit 30 includes a shaft 31 which the disk 3 is coupled to and supported on, and a spindle motor 35 connected to the shaft 31 to rotate the disk 3.

The spindle motor 35 is combined with a lower end of the shaft 31 to rotate the shaft 31, thereby rotating the disk 3 coupled to the shaft 31. Further, the spindle motor 35 is seated on a base member 5.

The shaft 31 stands upright to be combined with the spindle motor 35, has a predetermined length, and has an upper end combined to the disk 3 by a combination unit, such as a screw, so that the disk 3 is rotated together with the shaft 31.

Four pickup transferring units 20 are arranged in a circular direction around the disk driving unit 30 and in different radial directions of the shaft 31 and disposed at right angles with each other with respect to the shaft 31 to transfer the corresponding pickup 10 toward the disk driving unit 30 in corresponding ones of the radial directions of the shaft 31. Each pickup transferring unit 20 includes a pickup holder 21 holding the pickup 10, an angle adjusting part 25 connected to the pickup holder 21 to adjust an angle of the pickup holder 21 with respect to the pickup inspecting apparatus 1, and a feed motor 27 connected to the angle adjusting part 25 to transfer the pickup 10 held by the pickup holder 21 to the disk driving unit 30.

The pickup holder 21 detachably holds and supports the pickup 10. The angle adjusting part 25 is provided under the pickup holder 21 and includes a first skew motor 25a and a second skew motor 25b which are controlled by a controller 40 to adjust the angle of the pickup 10 held by the pickup holder 21. Under the angle adjusting part 25 is provided a guide block 29 combined with the feed motor 27 by a spindle 28, and on the base member 5 is provided a guide rail 7 to guide the guide block 29.

The feed motor 27 is seated outside the angle adjusting part 25 and connected to the guide block 29 by the spindle 28. The spindle 28 has first external threads, and the guide block 29 has second internal threads to be engaged with the first external threads of the spindle 28, so that the spindle 28 passes through the guide block 29 by a screw-nut combination. Hence, when the feed motor 27 rotates the spindle 28, the guide block 29 coupled to the spindle 28 by the screw-nut combination moves along the guide rail 7 provided on the base member 5, and a moving direction of the guide block 29 varies according to a rotating direction of the feed motor 27 controlled by the controller 40.

A determiner 45 determines whether each pickup 10 passes predetermined inspections based on a first signal received from each pickup 10 reading the data recorded on the disk 3, and transmits each first signal received from the corresponding pickup 10 to the controller 40 by a time division method and a determination signal (a second signal) to a computer system 50 to display a determination.

The controller 40 controls the angle adjusting part 25 and the feed motor 27 to initialize the pickup 10 and the spindle motor 35 to rotate the disk 3 when the pickup 10 is put on the pickup holder 21, and controls the laser beam emitted from the photo diode of the pickup 10. Further, the controller 40 receives the first signal of each pickup 10 according to the time division method through the determiner 45 and then controls the angle adjusting part 25 and the feed motor 27 to change a relative position of the pickup 10 and the spindle motor 35 to change a rotation of the disk 3.

The computer system 50 initially transmits a third signal to the controller 40 to initialize each pickup 10 and rotate the disk 3 and a fourth signal to the determiner 45 to receive the first signal from each pickup 10 and determine the performance of each pickup 10. Further, the computer system 50 displays the determination of whether the pickup 10 passes the predetermined inspections based on the determination signal received from the determiner 45.

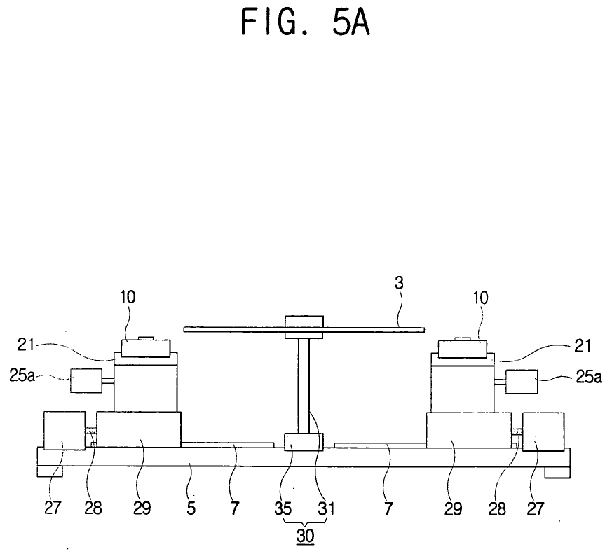

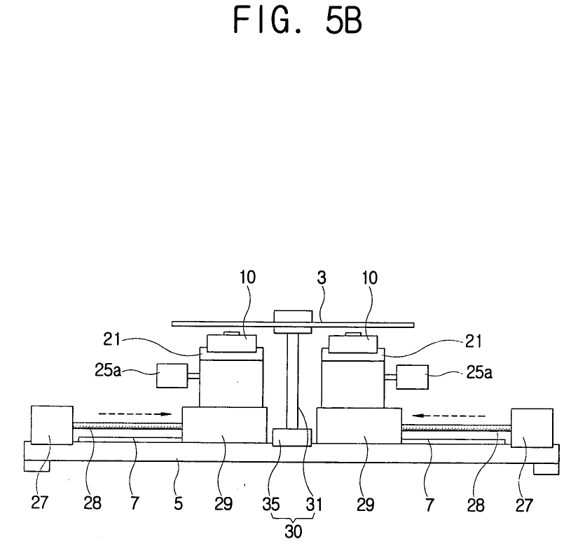

With this configuration, the pickup inspecting apparatus 1 operates as follows. First, four pickups 10 are respectively put on four pickup holder 21, and the disk 3 is coupled to the shaft 31 (see FIG. 5A). Then, the computer system 50 transmits the third signal to the controller 40, so that the controller 40 controls the angle adjusting part 25, the feed motor 27 and the spindle motor 35 to initialize the pickup 10 and the disk 3 (see FIG. 5B). Further, the computer system 50 transmits the fourth signal to the determiner 45, so that the determiner 45 determines whether each pickup 10 passes one of the predetermined inspections based on the first signal received from each pickup 10 reading the data from the disk 3. Then, the determiner 45 transmits the first signal received from the pickup 10 to the controller 40 by the time division method and the determination signal to the computer system 50 to display the determination. Then, the controller 40 controls the relative position between the pickup 10 and the disk 3 to be changed for a next inspection (another one of the predetermined inspections) after receiving the determination signal from the determiner 45. Here, the determiner 45 receives again the first signal from each pickup 10 and determines whether the pickup 10 passes the next inspection, and thus the above-described operations are repeated until a programmed inspection having the predetermined inspections is finished, thereby determining whether the performance of the pickup 10 is inferior, and displaying the determination on the computer system.

Thus, the pickup inspecting apparatus 1 includes the four pickup transferring units 20 with respect to one disk driving unit 30, so that the four pickups 10 are inspected at once, thereby improving an inspection efficiency of the pickup inspecting apparatus 1.

In the foregoing embodiment, the four pickup transferring units 20 are arranged in the circular direction around the disk driving unit 30 to transfer the corresponding pickups 10 to the disk driving unit 30 in a radial direction of the shaft 31. However, the invention is not limited thereto, and at least one pickup transferring unit 20 may be arranged in a radial direction around the disk driving unit 30, so that the at least one pickup 10 can be inspected at once.

As described above, the present invention provides a pickup inspecting unit improving the inspection efficiency.

Although an embodiment of the present invention has been shown and described, it will be appreciated by those skilled in the art that changes may be made in the embodiment without departing from the principles and spirit of the invention, the scope of which is defined in the appended claims and their equivalents.

What is claimed is:

1. A pickup inspecting apparatus inspecting performance of pickups mounted to a disk drive and reading data from a disk, comprising:
a disk driving unit rotatably supporting a disk; and
a plurality of pickup transferring units disposed around the disk driving unit, each holding a corresponding one of the pickups and transferring the pickups to the disk driving unit to read data recorded on the disk, so that the pickups held by corresponding ones of the pickup transferring units are inspected at once.

2. The pickup inspecting apparatus according to claim 1, further comprising:
a determiner transmitting a signal received from each pickup by a time division method; and
a controller controlling each pickup by receiving the signal of the pickup according to the time division method from the determiner.

3. The pickup inspecting apparatus according to claim 1, wherein the disk driving unit comprises:
a shaft to which the disk is supported; and
a spindle motor connected to the shaft to rotate the disk.

4. The pickup inspecting apparatus according to claim 3, further comprising:
a determiner transmitting a signal received from each pickup by a time division method; and
a controller controlling each pickup by receiving the signal of the pickup according to the time division method from the determiner.

5. The pickup inspecting apparatus according to claim 3, wherein the pickup transferring unit comprises:
a pickup holder holding the pickup;
an angle adjusting part connected to the pickup holder to adjust an angle of the pickup holder with respect to the disk driving unit; and
a feed motor connected to the angle adjusting part to transfer the pickup held by the pickup holder to the disk driving unit.

6. The pickup inspecting apparatus according to claim 5, further comprising:
a determiner transmitting a signal received from each pickup by a time division method; and
a controller controlling each pickup by receiving the signal of the pickup according to the time division method from the determiner.

7. The pickup inspecting apparatus according to claim 5, further comprising:
a base member on which the disk driving unit and the pickup transferring units are seated, wherein the spindle motor is seated on the base member, the shaft is connected to the spindle motor, and the disk is coupled to the shaft so as to rotate together with the shaft.

8. The pickup inspecting apparatus according to claim 7, further comprising:
a determiner transmitting a signal received from each pickup by a time division method; and
a controller controlling each pickup by receiving the signal of the pickup according to the time division method from the determiner.

9. The pickup inspecting apparatus according to claim 7, further comprising:
a guide block combined with the angle adjusting part under the angle adjusting part; and
a guide rail provided on the base member to guide the guide block, wherein the feed motor is connected to the guide block and moves the guide block along the guide rail.

10. The pickup inspecting apparatus according to claim 9, further comprising:
a determiner transmitting a signal received from each pickup by a time division method; and
a controller controlling each pickup by receiving the signal of the pickup according to the time division method from the determiner.

11. The pickup inspecting apparatus according to claim 9, wherein the number of the pickup transferring units is 4 and arranged around the disk driving unit.

12. The pickup inspecting apparatus according to claim 11, further comprising:
a determiner transmitting a signal received from each pickup by a time division method; and
a controller controlling each pickup by receiving the signal of the pickup according to the time division method from the determiner.

13. A pickup inspecting apparatus inspecting performance of a plurality of pickups, comprising:
a disk driving unit rotatably supporting a disk; and
a plurality of pickup transferring units disposed around the disk driving unit to transfer the pickups to the disk driving unit, wherein the pickups are inspected at once in a programmed inspection.

14. The pickup inspecting apparatus according to claim 13, wherein the disk driving unit is a single driving unit, and the disk is a single disk.

15. The pickup inspecting apparatus according to claim 13, wherein the number of the pickup transferring units is more than 2.

16. The pickup inspecting apparatus according to claim 13, wherein the disk has a radius, and the pickup transferring units move in a radial direction of a center of the disk by a distance greater than the radius.

17. The pickup inspecting apparatus according to claim 13, wherein the pickup transferring units move between a first area corresponding to an inside area of the disk and a second area corresponding to an outside area of the disk.

18. The pickup inspecting apparatus according to claim 13, wherein the pickup transferring units move to pass through a circular line having the same radius as the disk.

19. The pickup inspecting apparatus according to claim 13, wherein all of the pickup transferring units are disposed in a circular area having the same radius of the disk.

20. The pickup inspecting apparatus according to claim 13, wherein all of the pickup transferring units are disposed around the disk driving unit in an outside of an area corresponding to the disk

21. A pickup inspecting apparatus inspecting performance of a plurality of pickups, further comprising:
a base member;
a disk driving unit mounted on the base member to rotatably support a disk;
a plurality of pickup transferring units mounted on the base member and disposed around the disk driving unit; and
a controller controlling the pick transferring units to transfer the pickups to the disk driving unit and controlling the pickups to read data from the disk to be inspected at once.

22. The pickup inspecting apparatus according to claim 21, wherein the disk driving unit is a single driving unit, and the disk is a single disk.

23. A pickup inspecting apparatus inspecting performance of a pickup used in a disk drive, comprising:
a base member;
a disk driving unit mounted on the base member and having a spindle motor and a shaft rotatably coupled to the spindle motor; and
a plurality of pickup transferring units mounted on the base member and disposed around the disk driving unit to be spaced-apart from each other in different radial directions of the shaft.

24. The pickup inspecting apparatus according to claim 13, wherein the disk driving unit is a single driving unit.

25. The pickup inspecting apparatus according to claim 23, wherein the pickup transferring units are disposed within a circular area around the shaft of the disk driving unit.

26. The pickup inspecting apparatus according to claim 23, wherein the pickup transferring units are disposed in a circular direction of the shaft of the disk driving unit.

27. The pickup inspecting apparatus according to claim 23, wherein the pickup transferring units are disposed in an inspection area.

28. The pickup inspecting apparatus according to claim 23, wherein each pickup transferring unit moves between a first position spaced-apart from the shaft by a first distance and a second position spaced-apart from the shaft by a second distance greater than the first distance.

29. The pickup inspecting apparatus according to claim 28, wherein the first position is an inspection area, and the second position is a non-inspection area.

30. The pickup inspecting apparatus according to claim 29, wherein the pickup transferring units move sequentially along respective paths disposed between the corresponding first and second positions.

31. The pickup inspecting apparatus according to claim 29, wherein the pickup transferring units move simultaneously along respective paths disposed between the corresponding first and second positions.

32. The pickup inspecting apparatus according to claim 29, wherein the pickup transferring units move in a radial direction of the shaft of the disk driving unit.

33. The pickup inspecting apparatus according to claim 29, wherein the first position and the second position are disposed in a radial direction of the shaft of the disk driving unit.

34. The pickup inspecting apparatus according to claim 23, wherein the pickup transferring units are disposed opposite to each other with respect to the shaft of the disk driving unit.

35. A method in a pickup inspecting apparatus inspecting performance of a plurality of pickups, comprising:
rotatably supporting a disk on a disk driving unit; and
disposing a plurality of pickup transferring units around the disk driving unit; and
transferring a plurality of pickups disposed in corresponding ones of the pickup transferring units to the disk driving unit; and
inspecting all of the pickups at once.

36. The method according to claim 35, wherein the disk driving unit is a single driving unit, and the disk is a single disk.

37. A method in a pickup inspecting apparatus inspecting performance of a plurality of pickups, further comprising:
causing a disk driving unit and a plurality of pickup transferring units to be mounted on a base member;
rotatably supporting a disk on the disk driving unit; and
moving the pickup transferring units toward and away from the disk driving unit to transfer the pickups disposed on corresponding ones of the pickup transferring units to the disk driving unit to read data from the disk and inspect all of the pickups.

38. The method according to claim 37, wherein the disk driving unit is a single driving unit, and the disk is a single disk.

39. A method in a pickup inspecting apparatus inspecting performance of a plurality of pickups used in a disk drive, comprising:
causing a disk driving unit and a plurality of pickup transferring units to be mounted on a base member;
rotating a shaft rotatably coupled to a spindle motor disposed on the disk driving unit;
causing the pickup transferring units to be disposed around the disk driving unit and spaced-apart from each other in different radial directions of the shaft; and
controlling all of the pickup transferring units to be disposed around the shaft.

40. The method according to claim 39, wherein the disk driving unit is a single driving unit.
